(19) United States
(12) Patent Application Publication
(10) Pub. No.: US 2010/0327819 A1
(43) Pub. Date: Dec. 30, 2010

(54) CAPACITOR WITH AN INTERNAL DUMP RESISTANCE

(75) Inventor: Frederick W. MACDOUGALL, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignee: GENERAL ATOMICS, San Diego, CA (US)

(21) Appl. No.: 12/831,955

(22) Filed: Jul. 7, 2010

Related U.S. Application Data
(63) Continuation-in-part of application No. 12/821,072, filed on Jun. 22, 2010.
(60) Provisional application No. 61/219,357, filed on Jun. 22, 2009.
(60) Provisional application No. 61/255,446, filed on Oct. 27, 2009.
(60) Provisional application No. 61/223,680, filed on Jul. 7, 2009.
(60) Provisional application No. 61/223,680, filed on Jul. 7, 2009.

(51) Int. Cl. H02J 7/00

(52) U.S. Cl. 320/166

(57) ABSTRACT

The present embodiments provide a capacitor system, comprising a capacitor, a switch, and an internal dump resistor coupled with the switch, such that the switch when activated couples the internal dump resistor with the capacitor to drain a charge from the capacitor.

This application claims the benefit of U.S. Provisional Application No. 61/223,680, filed Jul. 7, 2009, entitled CAPACITOR WITH AN INTERNAL DUMP RESISTANCE, for Frederick W. MacDougall, which is incorporated in its entirety herein by reference; and this application is a continuation-in-part of U.S. application Ser. No. 12/821,072, filed Jun. 22, 2010, entitled CHARGED CAPACITOR WARNING SYSTEM AND METHOD, for MacDougall et al., which claims the benefit of U.S. Provisional Application No. 61/219,357, filed Jun. 22, 2009, entitled CHARGED CAPACITOR WARNING SYSTEM AND METHOD, for MacDougall et al., the benefit of U.S. Provisional Application No. 61/255,446, filed Oct. 27, 2009, entitled CHARGED CAPACITOR WARNING SYSTEM AND METHOD, for MacDougall et al., and the benefit of U.S. Provisional Application No. 61/223,680, filed Jul. 7, 2009, entitled CAPACITOR WITH AN INTERNAL DUMP RESISTANCE, for Frederick W. MacDougall, all of which are incorporated in their entirety herein by reference.

### BACKGROUND

1. Field of the Invention

The present invention relates generally to capacitors, and more specifically to capacitor systems.

2. Discussion of the Related Art

Capacitors have a wide range of uses. Further, high voltage high energy capacitors can be employed in a large number of applications. For example, some high voltage high energy capacitors are used to rapidly discharge and to deliver power to a corresponding system.

### SUMMARY OF THE INVENTION

Several embodiments of the invention advantageously address the needs above as well as other needs by providing capacitor system, comprising a capacitor; a switch; and an internal dump resistor coupled with the switch, such that the switch when activated couples the internal dump resistor with the capacitor to drain a charge from the capacitor.

Other embodiments provide a capacitor device, comprising a capacitor; dump resistance electrically coupled with the capacitor; a case, where the capacitor and the dump resistance are housed within the casing; a first electrode extending from the casing and coupling with a first lead of the capacitor; a second electrode extending from the casing and coupling with a second lead of the capacitor; and a switch coupled between the capacitor and the dump resistance, where the switch, when activated, couples the dump resistance with the capacitor to discharge a charge on the capacitor.

Still other embodiments provide methods of discharging a capacitor. Some of these methods detect a command to switch in an internal dump resistor; activate a switch to couple the internal dump resistor with a capacitor; and discharge, through the internal dump resistor, a charge from the capacitor.

### BRIEF DESCRIPTION OF THE DRAWINGS

The features and advantages of the present invention will be more apparent from the following more particular description thereof, presented in conjunction with the following drawings wherein:

FIG. 1 is a schematic of one embodiment of the internal dump resistor where an external switch is used to connect the dump resistor to the capacitor.

FIG. 2 is a depiction of a typical dump resistor that is made, in this embodiment, from a metal ribbon or wire to provide the resistance to discharge the capacitor.

FIG. 3 depicts an example component layout for a dump resistor in a large capacitor according to some embodiments.

FIG. 4 is a schematic of another embodiment for a dump resistor circuit where a dump resistor switch is internal to the capacitor case.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of the invention. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The present embodiments provide capacitor discharge circuitry and/or resistors where the discharge circuitry comprises one or more internal resistors that can be switched or optionally coupled with the capacitance to discharge the capacitance.

Some capacitors include a permanently connected and continuously discharging resistance. Some standards require that a discharge resistor be connected to the capacitor that will bleed or discharge the voltage down to less than 50 volts in 60 seconds for capacitors under 600 volts or in less than 300 seconds for capacitors over 600 volts. On large capacitors typically used in high energy discharge applications, a permanently connected discharge resistor of these types require significant energy to hold voltage on the capacitor due to the current that will flow through the discharge resistor. Another consideration is the heat that is continuously generated by these permanently connected discharge resistors because the heat typically decreases the life expectancy of the capacitor. This becomes a significant factor with high voltage applications, including pulse power systems that use large capacitance and wattage, and the amount of current that the dump resistors have to pass the heat generated is significant.

Some applications to the problem of discharging large pulse power capacitors can include adding an external dump resistor that is switched into the circuit when it is desirable to dump the energy stored in the capacitor. The dump resistor is externally mounted and must have an adequate thermal mass to handle multiple energy dumps.

The present embodiments provide capacitors with internal dump or discharge resistance or circuitry that can be switched into the circuit with an internal or external switch. The switch typically isolates the dump resistance from the circuit and can connect the dump resistance across the capacitor when it is desirable to dump or discharge the capacitor. The advantage of having internal dump circuitry or resistor(s), at least in part, is that the thermal mass of the capacitor can be used to absorb the energy that is turned into heat when the electrical energy in the capacitor is dumped. This, at least in part, makes relatively small dump resistors practical. Also, a dump resistor mounted internal to the capacitor is in an environment that can make it more tolerant of shock, vibration and/or other such factors that may degrade or damage the resistor. Still further, the internal dump resistance can take advantage of the electrical insulation provided by the capacitor insulation.

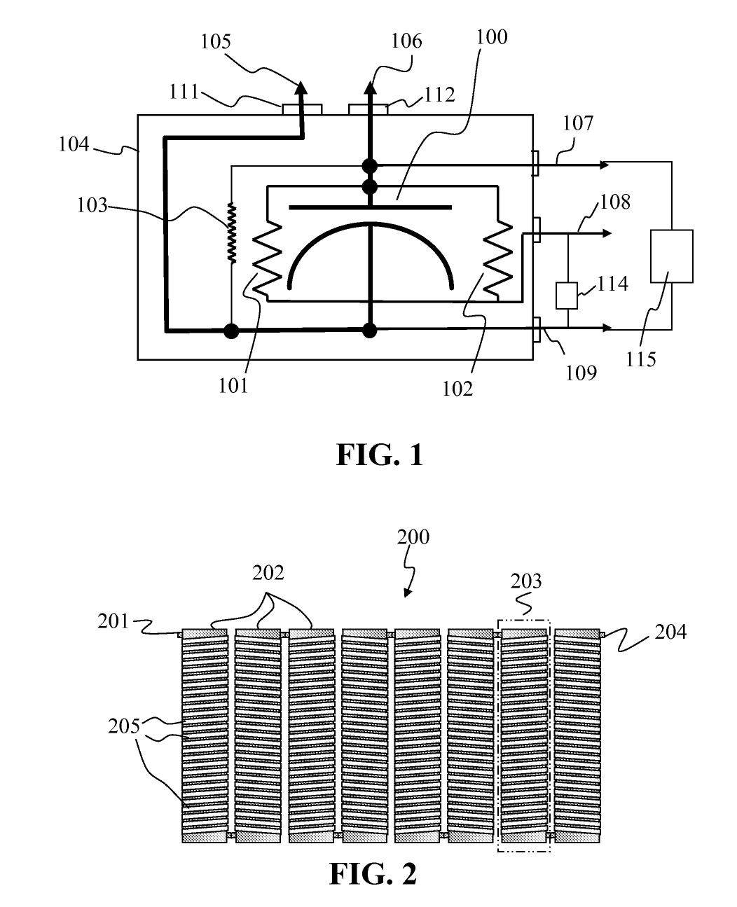

Referring to FIG. 1, a capacitor system or device is show including a large capacitor 100 mounted inside a case 104 with external high current, high voltage terminals 105 and 106, which in some instances pass through insulating bushings 111 and 112, respectively. One or more fixed safety discharge resistors 103 are connected in parallel with capacitor 100. Values for the components, in some instances, can typically be about 315 μF for capacitor 100 and 200 MΩ for resistor 103 resulting in an RC time constant of about 18 hours. If the capacitor is operating at 10 kV it will take approximately 4 days to discharge the capacitor down to 50 volts through the resistor 103. The resistor 103 provides a long term discharge fail safe that can discharge residual charges.

Also shone in FIG. 1 are dump resistors 101 and 102 that are connected to the high current terminal 106 of the capacitor and a low current high voltage terminal 108. Further shown are two additional high voltage low current terminals 107 and 109 electrically connected to terminals 106 and 105, respectively. During normal operations, in some instances, the capacitor will be charged with a charging power supply 115 through terminals 107 and 109 and discharged through terminals 105 and 106. If the capacitor 100 is charged and the decision is made to dump the energy in the capacitor 100; a switch 114, such as an external switch for example, can be used to connect terminal 108 to terminal 109 to connect the dump resistors 101 and 102 across capacitor 100. Exemplary values for the dump resistors 101 and 102 can be about 2 kΩ with respect to the example above. With the circuit shown in FIG. 1 and the values identified above, the RC time constant would be about 0.32 seconds. If the capacitor 100 is charged to 10 kV, the dump resistors 101 and 102 will discharge the capacitor to 50 volts in about 4 seconds. The resistance provided by the resistors 101 and 102 can be varied depending on the desired rate of discharge, a expected amount of charge, the capacitance, and the RC time constant. Further, the total resistance may depend on the switch 114 and the peak electrical current characteristics of the switch.

FIG. 2 depicts a layout of an internal dump resistor 200 according to some embodiments that is made up of a conductive material, such as a metal, composite metal, carbon composition, sinter carbon, conductive plastic and/or other such materials or combinations of materials. Additionally, in some instances, the conductive material is formed into a wire or ribbon 205 that is wound around an insulator 202. The terminations 201 and 204 of the resistor wire or ribbon are at the ends of an electrically continuous wire or ribbon 205. The length of the wire between these terminals and the resistance per length of wire determine the resistance value of the resistor 200. Typically, it is desirable to keep the winding of the wire or ribbon from coming into electrical contact with other windings and/or parts of the wire or ribbon since inadvertent contact could result in the loss of the impedance provided by the section of the wire that would be shorted out and arcing may occur between the wires. The insulator 202 can be employed in some embodiments to maintain positioning of the windings of the wire or ribbon 205 and/or maintain the electrical isolation between windings. In other embodiments, insulated wire is utilized to achieve this electrical isolation. In some implementations, the columns of wire 203 can be positioned adjacent to and/or laid on top of one another with insulation between the columns of wire 203. Further, the embodiment shown in FIG. 2 depicts the resistor 200 implemented through windings of the wire or ribbon 205, however, other configurations and/or structures can be employed in achieving the desired resistance, such as serpentine configuration, overlapped, multi-layers separated by insulation and other such configurations. In other embodiments, a two or more layers of winding can be employed with insulation between the layers to further increase resistance or achieve a desired resistance within a given size.

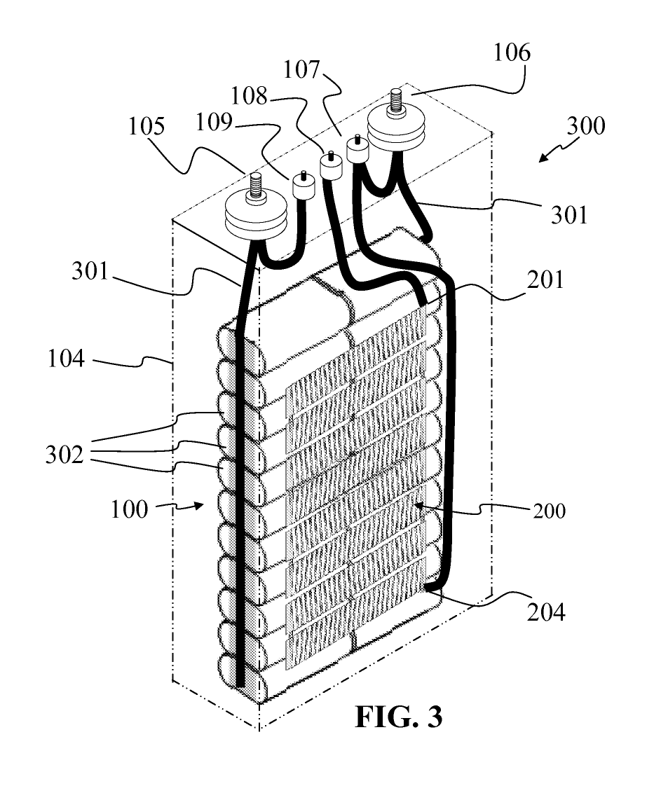

FIG. 3 depicts a capacitor system 300 according to some embodiments that comprises an internal dump resistor 200 positioned relative to the capacitor 100 according to some embodiments. In this embodiment, the dump resistor 200 of FIG. 2 is connected to the circuit between connection points 201 and 108 as well as 204 and 107. This dump resistor 200 is mounted between the individual winding pads 302 that make up capacitor 100 and the capacitor case 104. Leads or connection wires 301 electrically couple the internal capacitor 100 with the external high current, high voltage terminals 105 and 106. In some implementations the terminations 201 and 204 of the internal dump resistor 200 terminate under and/or within an insulation, such as an insulation tape, strip or the like, to aid in maintaining the structure and integrity of the wire or ribbon 205. For example, in some implementations the wire or ribbon 205 may be constructed from a relatively brittle or fragile material. As such, the terminations 201 and 204 of the internal dump resistor 200 can be terminated within or under insulation allowing the terminals to be further protected. Relatively flexible and electrically conductive leads, wiring, jump wires or the like (e.g., copper, copper alloy, or other relevant conductive and relatively flexible material) can electrically couple with the terminals 201 and 204 of the internal dump resistor 200 under and/or within the insulation allowing the charge across the capacitor 100 to be discharged when an internal or external switch is activated to connect the dump resistor 200 across the capacitance 100. Further, the conductive wire could be insulated or uninsulated, and with insulated the insulation is often high voltage insulation even though the voltage on the wire will be relatively low due to the internal dump resistor 200.

As described above, the internal dump resistor 200 can comprise one or more resistors coupled in cooperation across the one or more capacitors making up the capacitor 100, which in many implementations provides a high voltage high energy capacitance. For example, a capacitor system 300 can include one, five, ten, twenty or more resistors cooperatively coupled within the case 104 to form the internal dump resistor 200. The one or more resistors making up the internal dump resistor 200 can be coupled in series which are then coupled in parallel across the internal capacitor 100. In other embodiments, redundancy and/or circuit protection can be provided by configuring the internal dump resistor with one or more resistors coupled in parallel with one or more other resistors. For example, some embodiments include a first plurality of resistors coupled in series and a second plurality of resistors coupled in series, with the first plurality of resistors being coupled in parallel with the second plurality of resistors.

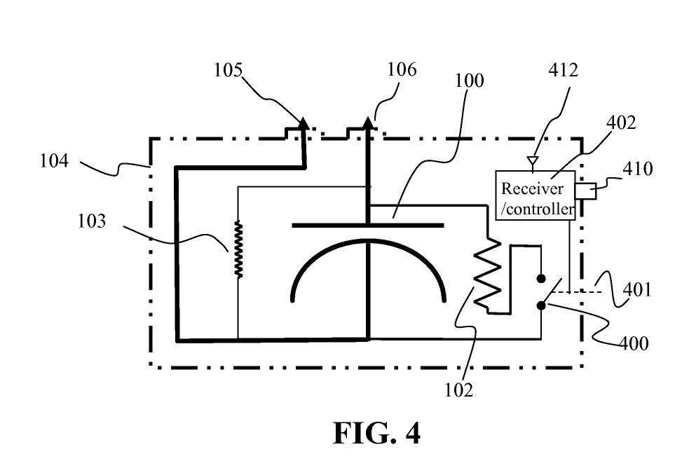

FIG. 4 is a variation on the circuit of the capacitor system shown in FIG. 1 where an internal dump switch 400 has been added that will connect dump resistor 102 across capacitor 100 draining the charge from that capacitor. If the same values are attached to the components as previously described, the RC time constant and time it will take to discharge the capacitor 100 to 50 volts will approximately double since resistor 101 is not included. In some embodiments, the resistance of resistor 102 (and/or capacitance) can be adjusted to control the discharge rate based on the RC time constant. The control of the internal dump switch 400, in some instances, will be from an external source such as a mechanical connection 401 going through the case 104.

In some embodiments, an internal control circuit 402 is included where an external electrical signal, radio signal or optical signal is used to control switch 400. The internal control circuit 402 can additionally include a receiver/transmitter 412 that allows the control circuit 402 to receive wireless communications. An optional window or port 410 can additionally or alternatively be provided in the case 104 to allow for the detection and/or transmission of optical signals.

The wiring or ribbon 205 included in the resistor 200 is made of sufficient material to withstand the applied voltages and currents intended to be discharged from the capacitor 100. Typically, the wire or ribbon 205 is constructed of a metal or metal alloy providing the discharging of the capacitor. In some embodiments, one or more heat sinks or coolants can be included to aid in dissipating heat from the resistor 200. For example, the resistor 200 can be surrounded by a coolant or oil, such as the dielectric fluid of the capacitor, that can dissipate heat. In some implementations, for example, the wiring 205 can be 3.5 lbs of Chromel-C wire allowing the resistor to readily dissipate approximately 5×12.5 kJ while maintaining a surface temperature of the resistor 200 at about or below 100° C. The wire or ribbon 205 can be constructed of other materials providing the desired resistance while providing sufficient heat dissipation, such as but not limited to a nickel or nickel alloy (e.g., a nickel-chromium alloy).

As representative examples, the wire can be a 20 gauge wire, be formed by a 1 mil×5 mil ribbon and other such wiring or ribbon. Again, however, the present embodiments are not restricted to a wound ribbon or wire and other configurations can be employed. Further, the configuration of the wire, ribbon or other structure can be implemented to achieve the desired RC time constant while achieving a desired thermal time constant. A surrounding oil, coolant or other heat sink can additionally be employed, such as a fluid dielectric of the capacitor, to allow for heat dissipation and allow for repeated discharging. Additionally in some instances, the heat dissipated through the fluid allows the dump resistor to be constructed with reduced amounts of material. As a further example, the wiring can be wound around a first PET electrically insulating tape with this cooperation being further sandwiched between two wider tapes of insulation. Again, the material and structure of the wire, ribbon or the like in making up the internal dump resistor 200 can be selected to provide a desired thermal time constant. In some implementations, the internal dump resistor 200 is constructed to have a relatively low thermal time constant relative to the energy supplied to the internal dump resistor and as such the wire or ribbon cools off faster than the energy supplied can heat the wire or ribbon. However, longer or shorter thermal time constants can be employed.

The present embodiments can be employed with wet or dry capacitors. With wet capacitors, the dump resistance can take advantage of the dielectric fluid as a coolant to further dissipate heat. Other methods can additionally or alternatively be employed to dissipate head from the dump resistance.

Some embodiments provide capacitor devices that comprise a capacitor, a dump resistance electrically coupled with the capacitor, a case, where the capacitor and the dump resistance are housed within the casing, a first electrode extending from the casing and coupling with a first lead of the capacitor, a second electrode extending from the casing and coupling with a second lead of the capacitor, and a switch coupled between the capacitor and the dump resistance, where the switch, when activated, couples the dump resistance with the capacitor to discharge a charge on the capacitor. In some instances, the capacitor device can further comprise a control circuit coupled with the switch to control the activation of the switch to connect the capacitor with the dump resistance. Further, the switch and the control circuit can be enclosed within the case. Additionally, the control circuit can comprise a wireless receiver to wirelessly receive instructions to control the switch. Further still, the dump resistance of the capacitor device can comprise a first resistor and a second resistor coupled in parallel.

In some implementations, the capacitor device can further include a third electrode extending from the casing and coupling with the first lead of the capacitor, and a fourth electrode extending from the casing and coupling with the second lead of the capacitor, such that the third and fourth leads are used to charge the capacitor; and a fifth electrode extending from the casing, where a first lead of the first resistor and a first lead of the second resistor couple with a first lead of the capacitor, and a second lead of the first resistor and a second lead of the second resistor electrically couple with the fifth lead; where the switch couples between the fourth electrode and the fifth electrode to connect the first and second resistors across the capacitor, when the switch is activated, to discharge the capacitor. Additionally or alternatively, the dump resistance of the capacitor device can comprise a first resistor, where a first lead of the first resistor electrically couples with the first lead of the capacitor coupled with the first electrode, and a second lead of the first resistor electrically couples with the switch; wherein the switch couples between the first resistor and a second lead of the capacitor to connect the first resistor across the capacitor, when the switch is activated, to discharge the capacitor.

The present embodiments provide large capacitors with internal and dump discharge circuitry that can be switched into or out of the circuit. The dump resistance, in some implementations, comprises one or more resistors that are switched into the circuit upon activation of a switch to discharge the capacitors. The discharge circuitry, at least in part, provides for the safe discharging of one or more capacitors in a relatively short time prior to the equipment being accessed by personnel. The dump or discharge circuitry provided by the present embodiments can be utilized with various types and capacities of capacitors. For example, the discharge circuitry can be utilized with capacitors rated at 10K VDC, 1000 μF, storing 50,000 Joules of energy.

Other embodiments can be employed with a typical defibrillator capacitor rated at 2,000 VDC, 100 μF, and storing 5-200 Joules or more, including 300K Joules, 1 M Joules and larger capacitance. Many capacitors, including the defibrillator capacitor and larger capacitors can pose a significant safety concern when the capacitors are charged. The present embodiments provide for the discharging of these capacitors.

While the invention herein disclosed has been described by means of specific embodiments and applications thereof, numerous modifications and variations could be made thereto by those skilled in the art without departing from the scope of the invention set forth in the claims.

What is claimed is:

1. A capacitor system, comprising:
a capacitor;
a switch; and
an internal dump resistor coupled with the switch, such that the switch when activated couples the internal dump resistor with the capacitor to drain a charge from the capacitor.

2. A capacitor system of claim 1, further comprising:
a capacitor case, wherein the capacitor, switch and internal dump resistor are internal to the capacitor case.

3. A capacitor system of claim 2, further comprising a control of the switch, where the control of the switch is external to the capacitor case with a mechanical connection extending through the capacitor case to couple with the internal dump resistor.

4. A capacitor of claim 2, further comprising:
an internal electronic controller positioned within the capacitor case, where control of the switch is done through the internal electronic controller internal to the capacitor case.

5. A capacitor of claim 4, wherein the internal electronic controller receives a signal to activate the switch and connect the internal dump resistor across the capacitor, where the incoming signal is an electrical signal.

6. A capacitor of claim 4, wherein the internal electronic controller receives a signal to activate the switch and connect the internal dump resistor across the capacitor, where the incoming signal is an optical signal.

7. A capacitor of claim 1, wherein the internal dump resistor comprises a multiple resistors, where the multiple resistors are connected in parallel and increasing a mass of the internal dump resistor.

8. A capacitor of claim 1 where the dump resistor comprises metal wire or ribbon.

9. A capacitor of claim 1 where the dump resistor comprises a carbon composition resistor.

10. A capacitor of claim 1 where the dump resistor comprises a conductive plastic.

11. A capacitor device, comprising:
a capacitor;
dump resistance electrically coupled with the capacitor;
a case, where the capacitor and the dump resistance are housed within the casing;
a first electrode extending from the casing and coupling with a first lead of the capacitor;
a second electrode extending from the casing and coupling with a second lead of the capacitor; and
a switch coupled between the capacitor and the dump resistance, where the switch, when activated, couples the dump resistance with the capacitor to discharge a charge on the capacitor.

12. A capacitor device of claim 11, further comprising:
a control circuit coupled with the switch to control the activation of the switch to connect the capacitor with the dump resistance.

13. A capacitor device of claim 12, wherein the switch and the control circuit are enclosed within the case.

14. A capacitor device of claim 13, wherein the control circuit comprises a wireless receiver to wirelessly receive instructions to control the switch.

15. A capacitor device of claim 14, wherein the dump resistance comprises a first resistor and a second resistor coupled in parallel.

16. A capacitor device of claim 15, further comprising:
a third electrode extending from the casing and coupling with the first lead of the capacitor, and a fourth electrode extending from the casing and coupling with the second lead of the capacitor, such that the third and fourth leads are used to charge the capacitor; and
a fifth electrode extending from the casing, where a first lead of the first resistor and a first lead of the second resistor couple with a first lead of the capacitor, and a second lead of the first resistor and a second lead of the second resistor electrically couple with the fifth lead;
wherein the switch couples between the fourth electrode and the fifth electrode to connect the first and second resistors across the capacitor, when the switch is activated, to discharge the capacitor.

17. A capacitor device of claim 11, wherein the dump resistance comprises a first resistor, where a first lead of the first resistor electrically couples with the first lead of the capacitor coupled with the first electrode, and a second lead of the first resistor electrically couples with the switch;
wherein the switch couples between the first resistor and a second lead of the capacitor to connect the first resistor across the capacitor, when the switch is activated, to discharge the capacitor.

18. A capacitor device of claim 14, wherein the dump resistance comprises a first plurality of resistors coupled in series.

19. A capacitor device of claim 18, wherein the dump resistance comprises a second plurality of resistors coupled in series, where the second plurality of resistors are coupled in parallel with the first plurality of resistors.

20. A method of discharging a capacitor, the method comprising:
detecting a command to switch in an internal dump resistor;
activating a switch to couple the internal dump resistor with a capacitor; and
discharging, through the internal dump resistor, a charge from the capacitor.
